(19) United States
(12) Patent Application Publication
(10) Pub. No.: US 2010/0142956 A1
(43) Pub. Date: Jun. 10, 2010

(54) Method and Apparatus for Reshaping a Channel Signal

(75) Inventors: Julia Y. Larikova, Naperville, IL (US); Richard C. Younce, Yorkville, IL (US); Mary E. Mizialko, Naperville, IL (US); Robert D. Gatze, Aurora, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operation, Inc., Naperville, IL (US)

(21) Appl. No.: 12/330,331

(22) Filed: Dec. 8, 2008

(51) Int. Cl. H04J 14/02

(52) U.S. Cl. 398/79

(57) ABSTRACT

Higher rate channels (e.g., 40 Giga bits or greater) have large bandwidths and are susceptible to inter-channel crosstalk. Optical tunable filters may be used to overcome crosstalk. Tunable filters do not maintain their central wavelength over a long duration or a wide temperature range. An example embodiment of the present invention relates to shaping a channel signal within a dense wavelength division multiplexing signal and may employ a tunable filter and input and output optical power detectors to measure a modulated source channel signal at an input of the tunable filter and a filtered modulated source channel signal at an output of the tunable filter. A controller is configured to adjust a center wavelength of the tunable filter as a function of a difference between measurements of optical power by the optical power detectors. Adjusting the center wavelength shapes the channel signal and overcomes undesired effects for higher rate channels.

### BACKGROUND OF THE INVENTION

Higher rate channels are making their way into networks initially designed for 10 Gbps. These higher rate services of 40 Giga bits per seconds (Gbps) and someday 100 Gbps have large bandwidths and, as such, are much more susceptible to inter-channel crosstalk effects.

Filtering techniques may be used to overcome the undesired crosstalk. However, insertion of a device such as an optical filter may result in a decrease of the transmitted signal power, which in telecommunication is referred to as “insertion loss.”

Optical tunable filters may be used to overcome undesired crosstalk effects. Unfortunately, tunable filters do not maintain their central wavelength well over a long period of time or a wide temperature range. Tunable filter shift off the channel center results in significant signal power degradation (i.e., insertion loss) through off-center filtering or complete signal extinction. Given their wavelength instability, tunable filters have not been commonly used to deal with crosstalk effects.

### SUMMARY OF THE INVENTION

A method or corresponding apparatus in an example embodiment of the present invention employs a tunable filter to shape a channel signal within a dense wavelength division multiplexing (DWDM) signal. An input optical power detector measures a modulated source channel signal at an input of the tunable filter. An output optical power detector measures a filtered modulated source channel signal at an output of the tunable filter. A controller is configured to adjust a center wavelength of the tunable filter as a function of a difference between measurements of optical power by the input optical power detector and the output optical power detector.

Another example embodiment of the present invention measures an optical power of a modulated source channel signal. The example embodiment filters the modulated source channel signal to generate a filtered modulated source channel signal and measures an optical power of the filtered modulated source channel signal. A center wavelength used in the filtering to filter the modulated source channel signal is adjusted as a function of a difference between measurements of optical powers.

Yet another example embodiment of the present invention shapes a channel signal within a dense wavelength division multiplexing (DWDM) signal using a tunable filter. A method or corresponding apparatus in this example embodiment adjusts a center wavelength of the tunable filter as a function of a difference between measurements of optical powers of a modulated source channel signal input to the tunable filter and a filtered modulated source channel signal output by the tunable filter.

Another example embodiment of the present invention adjusts a center bandwidth of a tunable filter. A method or corresponding apparatus in this example embodiment filters a modulated source channel signal to produce a filtered modulated source channel signal. The example embodiment measures an optical power of the modulated source channel signal and the filtered modulated source channel signal. The example embodiment adjusts the center bandwidth of the tunable filter as a function of a difference between measurements of the optical power of the modulated source channel signal and the filtered modulated source channel signal.

Yet another example embodiment of the present invention shapes a channel signal within a dense wavelength division multiplexing (DWDM) signal. The example embodiment adjusts a center wavelength of a tunable filter as a function of a pilot tone control of a modulated source channel signal and a filtered modulated source channel signal.

### BRIEF DESCRIPTION OF THE DRAWINGS

FIG. 1 illustrates an example of an optical communication network employing a module for reshaping a channel signal using an example embodiment of the present invention;

FIG. 2 illustrates an example embodiment of the present invention employing a module for reshaping a channel signal with a tunable filter;

FIG. 3 illustrates an example embodiment of the present invention for adjusting a center bandwidth of a tunable filter;

FIG. 4A is a plot that illustrates a relationship between a center wavelength of a tunable filter and an insertion loss in transmitted signal power according to an example embodiment of the present invention;

FIG. 4B is a plot that illustrates a relationship between an input power detector and an output power detector;

FIG. 5 illustrates an example embodiment of the present invention for shaping a signal channel;

FIG. 6 is an example embodiment of the present invention for adjusting a center bandwidth of a tunable filter;

FIG. 7 is an example embodiment of the present invention that adjusts a center bandwidth of a tunable filter; and

FIG. 8 illustrates a tunable filter for shaping a channel signal within a dense wavelength division multiplexing signal.

### DETAILED DESCRIPTION OF THE INVENTION

A description of example embodiments of the invention follows.

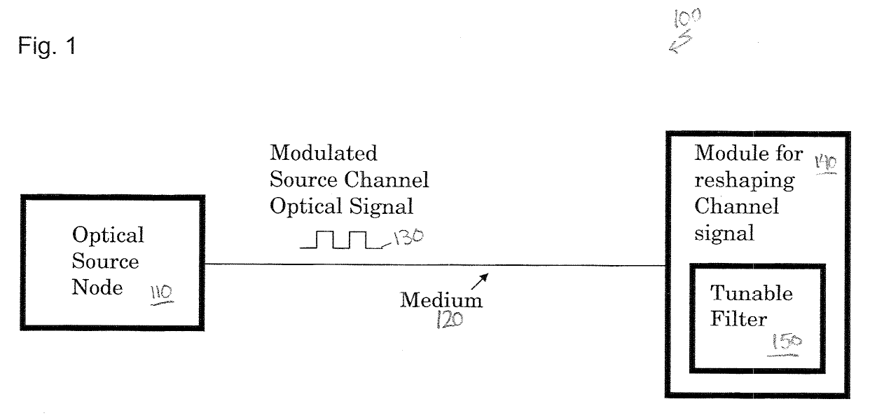

FIG. 1 illustrates an example of an optical communications network 100 employing a node that provides reshaping of a channel signal using an example embodiment of the present invention. In this example embodiment, an optical source node 110 (i.e., optical transmitter node) transmits a modulated source channel optical signal 130 (e.g., 40 Giga bits per seconds (Gbps) modulated optical signal) through a transmission path 120, which may include an optical fiber or other medium. For illustration purposes, the transmission path 120 is sometimes referred to herein as a fiber 120, but is not intended to be limited thereto. The optical signal 130 propagates through the fiber 120. The optical communication network 100 may include devices such as a tunable filter 150. A tunable filter 150 may be used in a optical communication network, such as the optical communication network of this example embodiment 100, to overcome large crosstalk effects caused by signals with large bandwidths, such as 40 Gbps signals. However, insertion of a device such as the tunable filter 150 in the transmission line 120 may result in an insertion loss (i.e., a loss in transmitted signal power) or a wavelength inaccuracy or drift. Additionally, tunable filters 150 do not maintain their central wavelength over a long period of time or over a wide temperature range. Tunable filters 150 may shift off the channel center, resulting in significant channel performance degradation through off-center filtering or complete channel extinction.

In order to compensate for the insertion loss, a module for reshaping the channel signal 140 according to an example embodiment of the present invention is employed to reduce or minimize the signal insertion loss. The insertion loss is minimal when the modulated source channel signal 130 and the tunable filter 150 are perfectly aligned (i.e., the modulated source channel signal 130 and the tunable filter 150 have the same center wavelength). The example embodiment 100 monitors the modulated source channel signal 130 before entering and after exiting the tunable filter 150, and continually or continuously adjusts the tunable filter 150 to ensure that the modulated source channel signal 130 and the tunable filter 150 are perfectly aligned.

In the view of the foregoing, the following description illustrates example embodiments and features that may be incorporated into a system for shaping a channel signal, where the term “system” may be interpreted as a system, subsystem, device, apparatus, method, or any combination thereof.

An example embodiment of the present invention relates to shaping a channel signal within a dense wavelength division multiplexing (DWDM) signal. A method or corresponding apparatus in this example embodiment employs a tunable filter. An input optical power detector measures a modulated source channel signal at an input of the tunable filter. An optical power detector measures a filtered modulated source channel signal at an output of the tunable filter. A controller is configured to adjust a center wavelength of the tunable filter as a function of a difference between measurements of optical power by the optical power detectors.

The modulated source channel signal may be a laser modulated source channel signal.

The system may filter the modulated source channel signal at a bandwidth narrower than a bandwidth of the modulated source channel signal. The system may adjust a bandwidth for filtering to have a narrower bandwidth than the modulated source channel signal to minimize crosstalk between the modulated source channel signal and a neighboring DWDM signal. The modulated source channel signal may be filtered using Gaussian filtering.

The system may adjust the center wavelength used for filtering to reduce optical wavelength drift. The center wavelength used for the filtering may be adjusted as a function of minimizing the difference between measurements of optical power by the optical power detectors. The center wavelength used for the filtering may also be adjusted as a function of maximizing the measurements of optical power by the output optical power detector. The system may apply dither control to the filtering and adjust the center wavelength used for the filtering as a function of the dither control.

The system may obtain the measurements of the optical power during predetermined time intervals. The system may measure at least one signal modulation parameter selected from a group consisting of amplitude modulation, frequency modulation, and phase modulation.

Another example embodiment of the present invention measures an optical power of a modulated source channel signal. The example embodiment filters the modulated source channel signal to generate a filtered modulated source channel signal, and measures an optical power of the filtered modulated source channel signal. A center wavelength used for the filtering of the modulated source channel signal is adjusted as a function of a difference between measurements of optical powers.

The modulated source channel signal may be a laser modulated source channel signal.

The system may filter the modulated source channel signal at a bandwidth narrower than a bandwidth of the modulated source channel signal. The system may adjust a bandwidth for filtering to have a narrower bandwidth than the modulated source channel signal to minimize crosstalk between the modulated source channel signal and a neighboring DWDM signal. The modulated source channel signal may be filtered using Gaussian filtering.

The system may obtain the measurements of the optical power during predetermined time intervals. The system may measure at least one signal modulation parameter selected from a group consisting of amplitude modulation, frequency modulation, and phase modulation.

The system may adjust the center wavelength used for filtering to reduce optical wavelength drift. The center wavelength used for the filtering may be adjusted as a function of minimizing the difference between measurements of optical power by the optical power detectors. The center wavelength used for the filtering may also be adjusted as a function of maximizing the measurements of optical power by the output optical power detector. The system may apply dither control to the filtering and adjust the center wavelength used for the filtering as a function of the dither control.

Yet another example embodiment of the present invention relates to a tunable filter for shaping a channel signal within a dense wavelength division multiplexing (DWDM) signal. A method or corresponding apparatus in this example embodiment adjust a center wavelength of the tunable filter as a function of a difference between measurements of optical powers of a modulated source channel signal input to the tunable filter and a filtered modulated source channel signal output by the tunable filter.

Another example embodiment of the present invention relates to adjusting a center bandwidth of a tunable filter. A method or corresponding apparatus in this example embodiment filters a modulated source channel signal to produce a filtered modulated source channel signal. The example embodiment measures an optical power of the modulated source channel signal and the filtered modulated source channel signal, and adjusts the center bandwidth of the tunable filter as a function of a difference between measurements of the optical power of the modulated source channel signal and the filtered modulated source channel signal.

Yet another example embodiment of the present invention relates to shaping a channel signal within a DWDM signal. The example embodiment adjusts a center wavelength of the tunable filter as a function of a pilot tone control of a modulated source channel signal and a filtered modulated source channel signal.

A pilot tone is typically a slow modulation of the modulated source signal by one or more of the following: amplitude modulation, frequency modulation, or phase modulation. The center wavelength used for filtering may be adjusted as a function of minimizing the difference between the pilot tone modulation parameters of the modulated source channel and the pilot tone modulation parameters of the filtered modulated source channel.

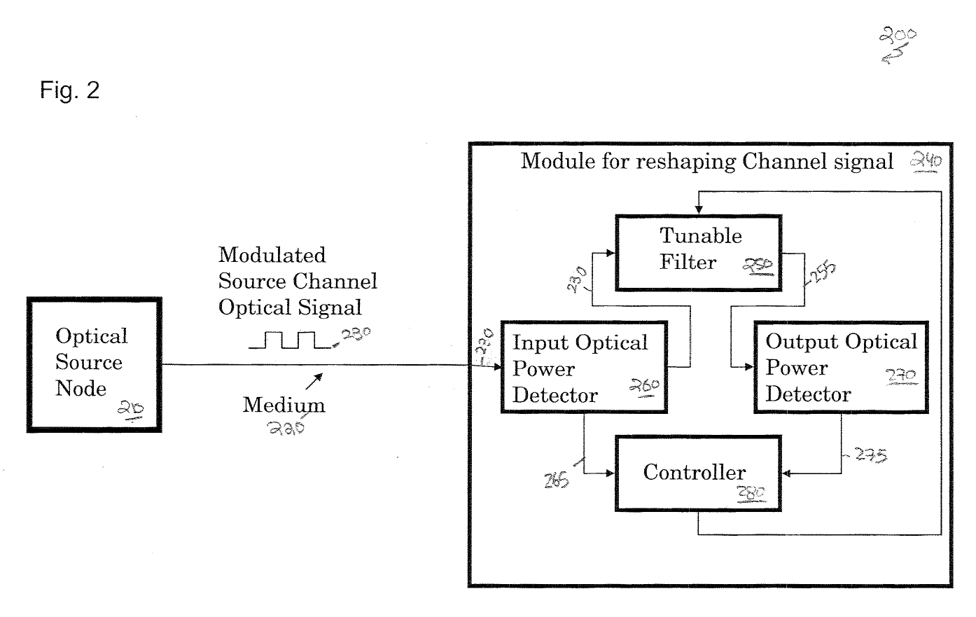

FIG. 2 illustrates optical communications network 200 employing a module for reshaping a channel signal 240 with a tunable filter 250 according to an example embodiment of the present invention.

In this example embodiment, an optical source node 210 (i.e., optical transmitter node) transmits a modulated source channel optical signal 230 (e.g., 40 Gbps modulated optical signal) through a transmission path 220, which may include an optical fiber. The optical signal 230 propagates through the fiber 220.

The module for reshaping channel signal 240 of this example embodiment 200 may include an input optical power detector 260 that measures an optical power of the input modulated source channel signal 230 into the tunable filter. Similarly, an output optical power detector 270 may measure the optical power of the filtered modulated source channel signal 255 exiting the tunable filter 250. In order to minimize the insertion loss caused by the tunable filter 250, the example embodiment 200 may employ a controller 280 that measures the difference between the optical power measurements 265, 275 of the modulated source channel signal 230 and the filtered modulated source channel signal 255, and continuously adjusts a center bandwidth of the tunable filter 250 to minimize the difference between the measurements of the optical powers 265, 275. The controller 280 may also adjust the center bandwidth of the tunable filter 250 by maximizing the measurement 275 of the optical power of the filtered modulated source channel signal 255. The controller may adjust the center bandwidth of the tunable filter 250 both to minimize the difference between the measurements of the optical powers and to maximize the optical power of the filtered modulated source channel signal 255.

The example embodiment 200 may employ one or more photodiodes to implement the input optical power detector 260 and/or the output optical power detector 270. By employing more than one photodiode, the example embodiment 200 eliminates any errors or unnecessary tuning that may be associated with any regular signal power fluctuations.

In order to overcome large crosstalk effects caused by the large bandwidth of 40 Gbps signals, the tunable filter 250 may be configured have a narrower bandwidth than the bandwidth of the modulated source channel signal. By narrowing the bandwidth of the source channel signal, the example embodiment 200 may overcome the crosstalk effects. By employing a tunable filter, the example embodiment may achieve as much as 3 Decibels (i.e., 3 dB) of improvement in the quality of the modulated source signal.

The tunable filter 250 may be configured as a Gaussian-shaped filter. When employing a Gaussian-shaped filter, the example embodiment may employ an optical differential phase-shift keying (DPSK) modulated signal. The example embodiment may employ a tunable filter 250 implemented with other filter types or shapes. The type or shape of the tunable filter may vary based on the application used. The tunable filter employed by the example embodiment 200 may be configured to be a colorless filter.

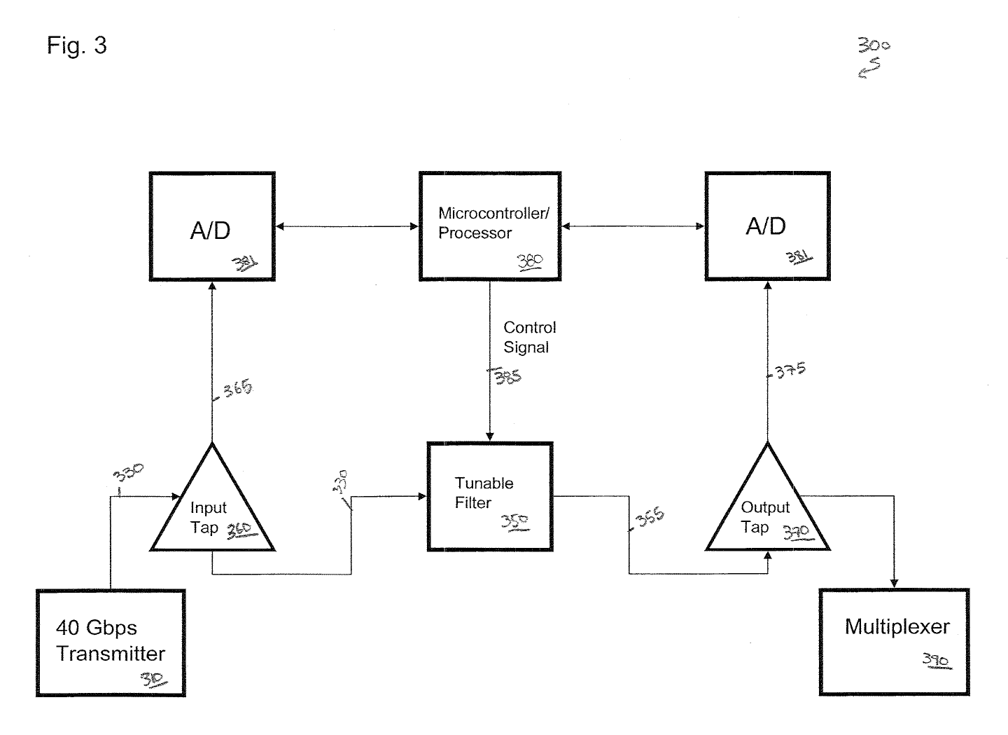

FIG. 3 illustrates an example embodiment 300 of the present invention for adjusting a center bandwidth of a tunable filter 350. The example embodiment 300 may receive the modulated source channel signal 330 from any optical source node 310, such as a 40 Gbps transmitter node 310. The optical source 310 may be a laser modulated source. The example embodiment 300 may employ return-to-zero or non-return-to-zero signals. The example embodiment 300 may employ modulated source channel signals 330 generated with various types of modulation techniques including frequency, phase, and/or amplitude modulation.

An input power detector 360 (e.g., an input tap photodiode) measures the power of the incoming modulated source signal 330. An analog-to-digital converter (A/D) 381 may be used to convert the measurements of power 365 by the input power detector 360 from analog to digital so they can be used by the controller 380.

Similarly, an output power detector 370 (e.g., an output tap photodiode) measures the power of the filtered modulated source signal 330. An analog to digital converter 381 may be used to convert the measurements of power 365 by the output power detector 370 from analog to digital so the measurements can be used by the controller 380.

The example embodiment 300 may obtain the power measurements during predetermined time intervals.

A controller 380, which may include a microcontroller, a processor, and/or a microprocessor, receives the measurements of power 365, 375 from the input power detector and the output power detector, and generates a control signal 385. The example embodiment 300 employs the control signal 385 to adjust a center wavelength of the tunable filter 350. Additionally, the example embodiment may employ the control signal 385 to adjust a bandwidth of the tunable filter 350.

The controller 380 may generate the control signal based on minimizing the difference between the measurements of the power 365 of the modulated source channel signal 330 and the power 375 of the filtered modulated source channel signal 355. The example embodiment may generate the control signal based on maximizing the power 375 of the filtered modulated source channel signal 355.

The controller 380 may employ dither control to adjust the center bandwidth of the tunable filter 350. To employ dither control, a dither signal having a dither frequency much lower (i.e., slower) than the frequency range of the tunable filter 350 is applied to the system to cause small deviations in performance that the controller 380 detects and then corrects. Alternatively, the dither control may be employed using amplitude modulation, where the dither amplitude modulation applied is much smaller than the amplitude sensitivity of the tunable filter 350 to cause small deviations in performance that the controller 380 detects and corrects.

The dither control may be employed using phase or frequency modulation, where the dither phase or frequency modulation applied is much smaller than the phase or frequency sensitivity of the tunable filter 350 to cause small deviations in performance that the controller 380 detects and corrects.

The example embodiment 300 may apply the control signal 385 to the tunable filter 350 to adjust a center wavelength of the tunable filter to control insertion loss. The example embodiment may also apply the control signal 385 to the tunable filter 350 to adjust the bandwidth of the tunable filter 350.

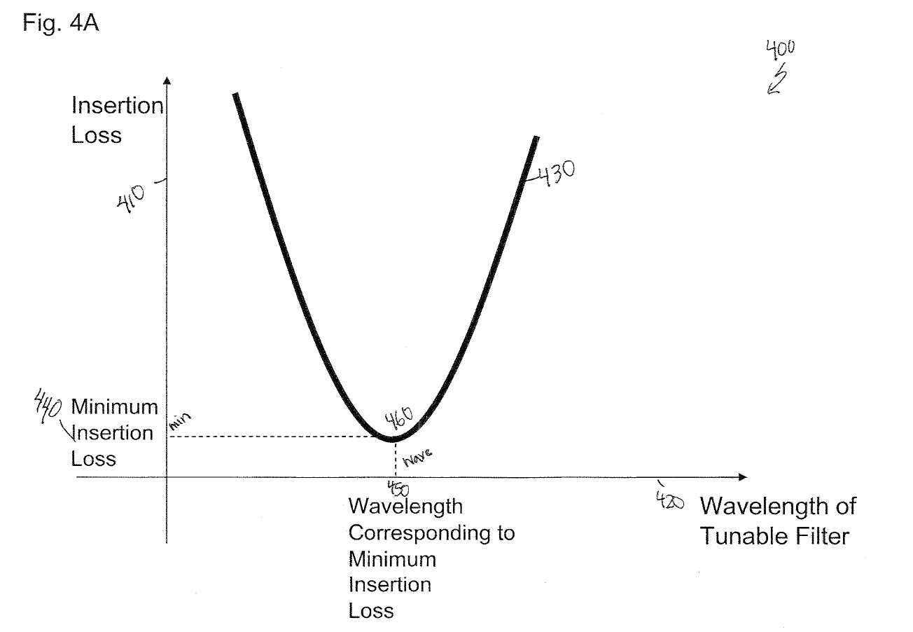

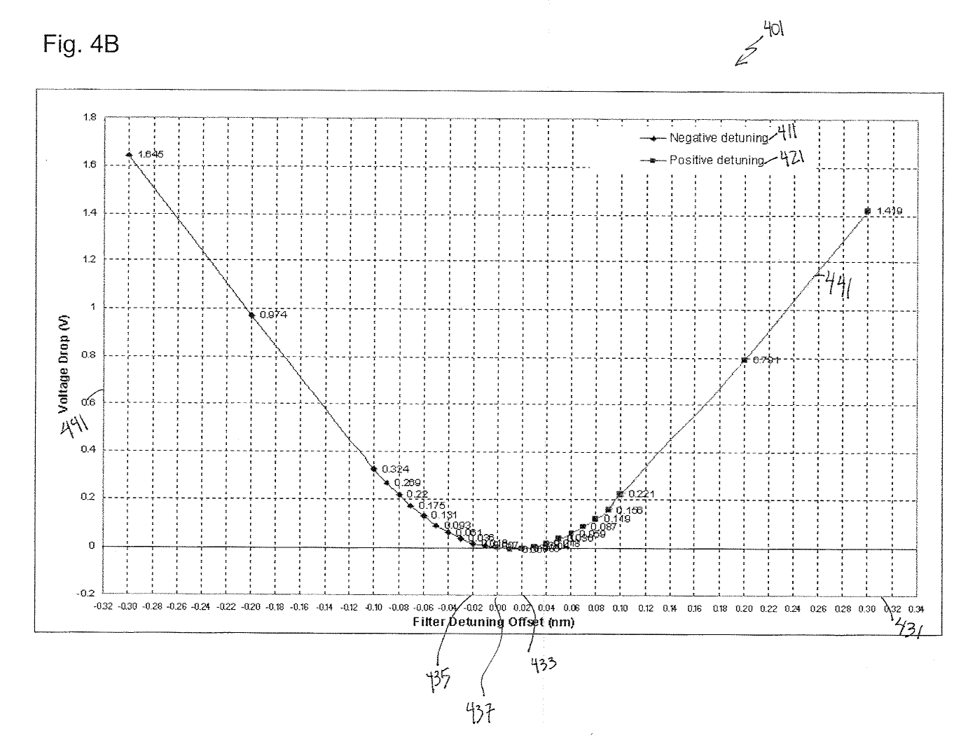

FIG. 4A is a plot 400 of a curve 430 that illustrates a relationship between wavelengths 420 of a tunable filter and an insertion loss 410 in transmitted signal power according to an example embodiment of the present invention. The insertion loss 410, shown on the vertical axis, represents the difference between the power of an input modulated source channel signal and an output filtered modulated source channel signal. In order to adjust the tunable filter, the example embodiment employs the measurements insertion loss 410 to search for a center wavelength 460 of the tunable filter that corresponds to the minimum insertion loss 440 (since having an insertion loss as close to zero as possible is ideal).

The example embodiment may monitor the power measurements during predetermined time intervals. For instance, the example embodiment may monitor the insertion loss 410 in one hour long time intervals to find the minimum insertion loss 440 and the center wavelength 420 corresponding to the minimum insertion loss 440. Once a minimum point 460 is obtained, the example embodiment may continue to monitor the power measurements during predetermined time intervals. For example, the example embodiment 400 may search locations positioned at 20 Pico-meters (or any other predetermined distance) to the left and 20 Pico-meters (or any other predetermined distance) to the right of the previously determined minimum 460 to look for a new minimum insertion loss. If a minimum insertion loss is not obtained the example embodiment may continue to search until it obtains a minimum insertion loss.

FIG. 4B is a plot 441 that illustrates a relationship between an input power detector (e.g., an input tap photodiode) and an output power detector (e.g., an output tap photodiode) as the wavelength 431 of a tunable filter (not shown) is adjusted in negative and positive directions.

In FIG. 4B, the change in a center wavelength 437 of the tunable filter in negative and positive directions is demonstrated on the horizontal axis 431 (labeled as “filter detuning offset”). The values on the horizontal axis 431 demonstrate the change in the center wavelength in nanometers (nm). As an example, the position 433 corresponding to 0.02 nm illustrates a 0.02 nm shift in the center wavelength 437 of the tunable filter in the positive direction of the horizontal axis. Similarly, the position 435 corresponding to −0.02 nm illustrates a 0.02 nm shift in the center wavelength 437 of the tunable filter in the negative direction of the horizontal axis.

The values on the vertical axis 441 demonstrate the insertion loss 410 (FIG. 4A) caused by the tunable filter. Here, the insertion loss 410 is demonstrated in terms of the voltage drop experienced between the input power detector and the output power detector. As noted previously, the example embodiment may measure the insertion loss 410 as a function of the difference between the optical power measurements of the modulated source channel signal and the filtered modulated source channel.

The tunable filter used to generate the data used in creating the curve 441 in the plot 401 of FIG. 4B may operate at a center wavelength configured using known optical standards. In this example, the center bandwidth of the tunable filter is offset from its original location 437 (shown as 0.00 on the horizontal axis), and the voltage drop resulting from this center bandwidth offset is recorded. As shown, any negative or positive change in the center bandwidth results in an insertion loss (i.e., voltage drop). For example, having 0.791 nm of positive shift in the center bandwidth of the tunable filter (i.e., positive detuning 411)may result in 0.8 Volt of insertion loss. Similarly, having 0.974 nm of negative shift in the center bandwidth of the tunable filter (i.e., negative detuning 421) may result in nearly 1 Volt of insertion loss.

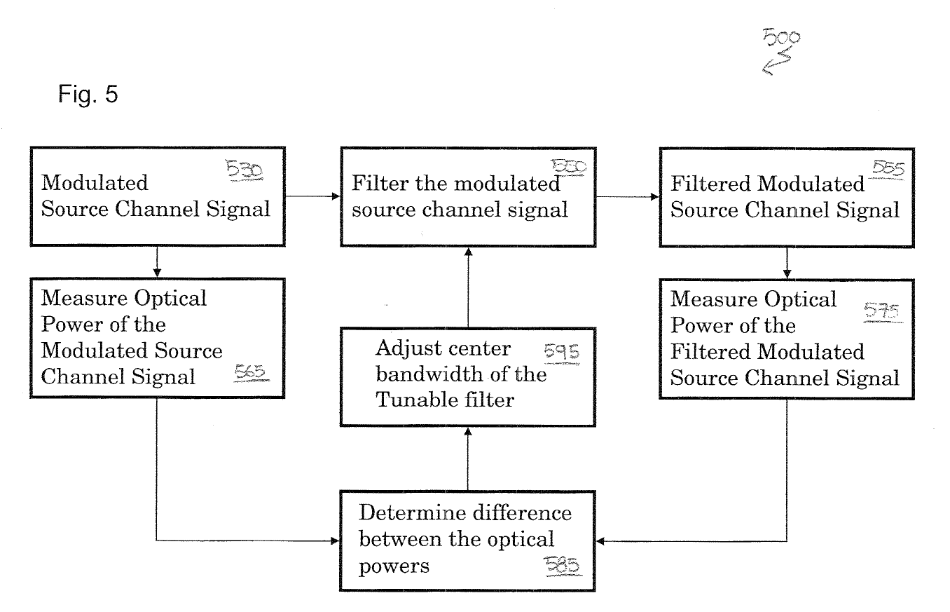

FIG. 5 illustrates an example embodiment 500 of the present invention for shaping a signal channel.

The example embodiment 500 measures an optical power 565 of a modulated source channel signal 530, and filters the modulated source channel signal 530 to produce a filtered modulated source channel signal 555. The example embodiment 500 also measures the optical power 575 of the filtered modulated source channel signal 555. Using the measured optical powers 555, 575, the example embodiment determines the difference 585 between these measurements 530, 555. A center bandwidth of the filter 550 is adjusted as a function of the difference between the measurements of optical powers 530, 555.

In order to minimize cross talk between the modulated source channel signal and a neighboring dense wavelength division multiplexing (DWDM) signal, the example embodiment may adjust the center wavelength of the filter to have a bandwidth narrower than the modulated source channel signal.

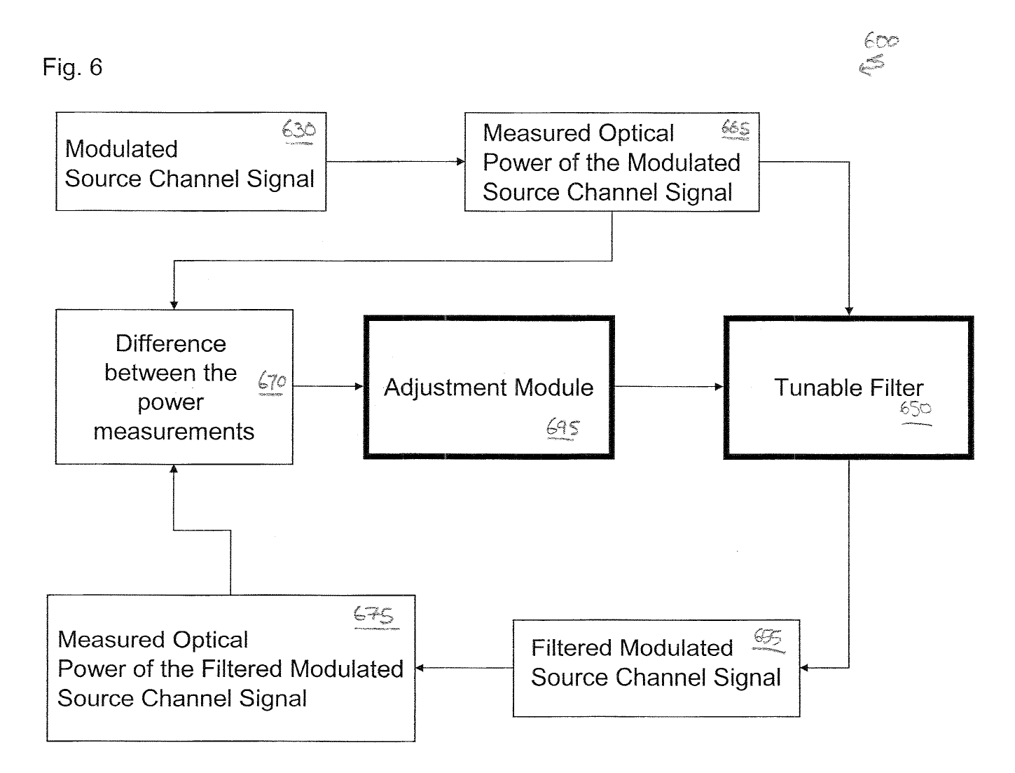

FIG. 6 illustrates an example embodiment 600 of the present invention for adjusting a center bandwidth of a tunable filter.

The example embodiment 600 includes an adjustment module 695 that adjusts a center wavelength of a tunable filter 650 as a function of a difference 670 between the power measurements 665, 675 of the modulated source channel signal 630 input to the tunable filter 650, and the filtered modulated source channel signal 655 output by the tunable filter 650.

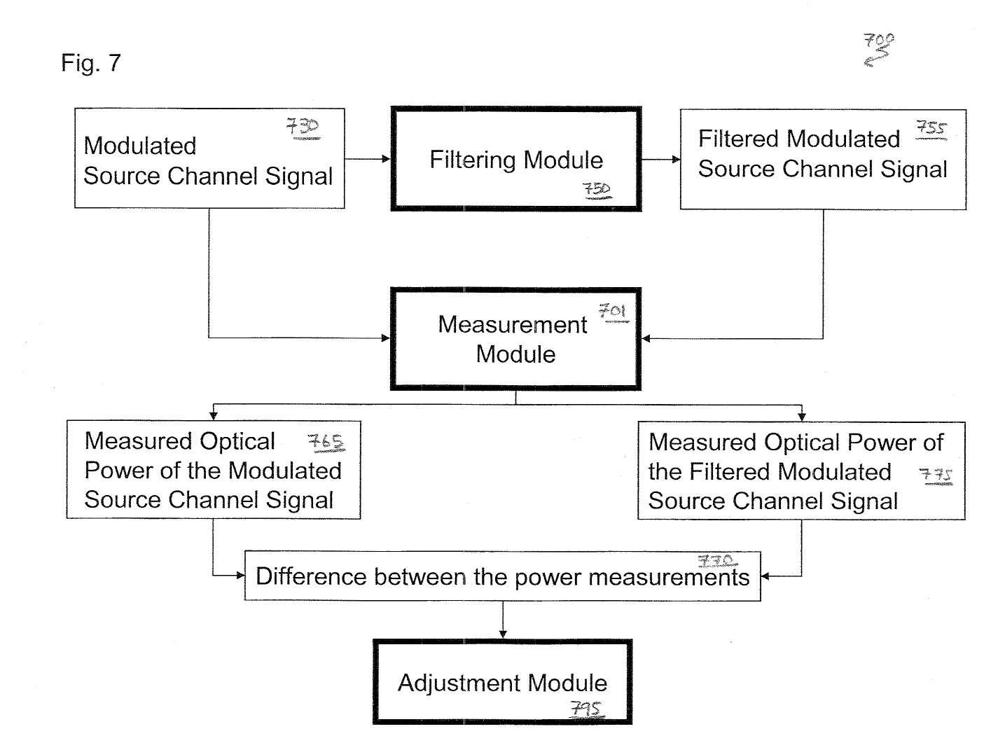

FIG. 7 is an example embodiment 700 of the present invention that adjusts a center bandwidth of a tunable filter.

The example embodiment 700 employs a filtering module 750 to filter a modulated source channel signal 730 to produce a filtered modulated source channel signal 755. The example embodiment 700 employs measurement module 701 to measure optical powers 765, 775 of the modulated source channel signal and the filtered modulated source channel signal. The example embodiment also obtains the difference between the optical power of the modulated source channel signal and the filtered modulated source channel signal 770. The example embodiment also includes an adjustment module 795 that adjusts the center bandwidth of the tunable filter based on the difference 770 between measurements 765, 775 of the optical power of the modulated source channel signal and the filtered modulated source channel signal.

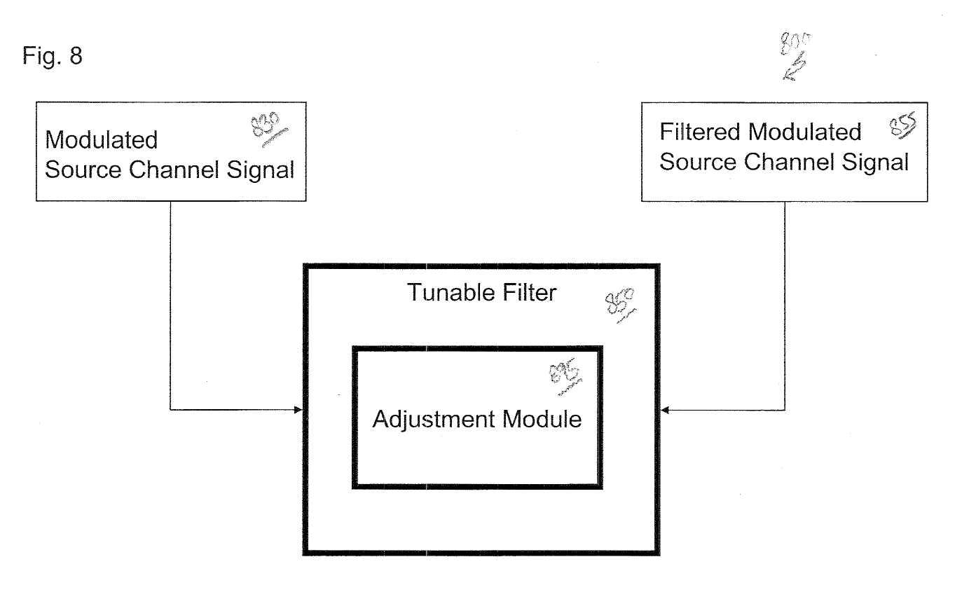

FIG. 8 illustrates a tunable filter 850 for shaping a channel signal within a DWDM signal according to an example embodiment 800 of the present invention. The tunable filter 850 includes an adjustment module 895 that adjusts a center wavelength of the tunable filter 850 as a function of a pilot tone control of a modulated source channel signal 830 and a filtered modulated source channel signal 855.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for shaping a channel signal within a dense wavelength division multiplexing (DWDM) signal, the apparatus comprising:
a tunable filter;
an input optical power detector and an output optical power detector to measure a modulated source channel signal at an input of the tunable filter and a filtered modulated source channel signal at an output of the tunable filter respectively; and
a controller configured to adjust a center wavelength of the tunable filter as a function of a difference between measurements of optical power by the optical power detectors to shape the channel signal within the DWDM signal.

2. The apparatus of claim 1 wherein the tunable filter is has a bandwidth narrower than a bandwidth of the modulated source channel signal.

3. The apparatus of claim 1 wherein the modulated source is a laser modulated source.

4. The apparatus of claim 1 wherein the controller is configured to tune a bandwidth of the tunable filter to have a narrower bandwidth than the modulated source channel signal to minimize crosstalk between the modulated source channel signal and a neighboring DWDM signal.

5. The apparatus of claim 1 wherein the controller is arranged to obtain the measurements of the optical power during predetermined time intervals.

6. The apparatus of claim 1 wherein the tunable filter is configured as a Gaussian filter.

7. The apparatus of claim 1 wherein the power detectors are configured to measure at least one signal modulation parameter selected from a group consisting of: amplitude modulation, frequency modulation, and phase modulation of a pilot tone and shape the channel signal in part as a function of the signal modulation parameter.

8. The apparatus of claim 1 wherein the controller is configured to adjust the center wavelength of the tunable filter to reduce optical wavelength drift.

9. The apparatus of claim 1 wherein the controller is configured to adjust the center wavelength of the tunable filter as a function of minimizing the difference between measurements of optical power by the optical power detectors.

10. The apparatus of claim 1 wherein the controller is configured adjust the center wavelength of the tunable filter as a function of maximizing the measurement of optical power by the output optical power detector.

11. The apparatus of claim 1 wherein the controller is configured to apply dither control to the tunable filter and adjust a center wavelength of the tunable filter as a function of the dither control.

12. A method for shaping a channel signal within a dense wavelength division multiplexing (DWDM) signal, the method comprising:
measuring an optical power of a modulated source channel signal;
filtering the modulated source channel signal to generate a filtered modulated source channel signal;
measuring an optical power of the filtered modulated source channel signal; and
adjusting a center wavelength used in the filtering to filter the modulated source channel signal as a function of a difference between measurements of optical powers to shape a channel signal within the DWDM signal.

13. The method of claim 12 wherein filtering the modulated source channel signal includes filtering at a bandwidth narrower than a bandwidth of the modulated source channel signal.

14. The method of claim 12 wherein the modulated source channel signal is a laser modulated source channel signal.

15. The method of claim 12 further including adjusting a bandwidth for filtering to have a narrower bandwidth than the modulated source channel signal to minimize crosstalk between the modulated source channel signal and a neighboring DWDM signal.

16. The method of claim 12 further including obtaining the measurements of the optical power during predetermined time intervals.

17. The method of claim 12 further including filtering the modulated source channel signal using Gaussian filtering.

18. The method of claim 12 further including measuring the modulated source channel signal or the filtered modulated source channel signal for at least one signal modulation parameter selected from a group consisting of: amplitude modulation, frequency modulation, and phase modulation of a pilot tone and shaping the channel signal in part as a function of the signal modulation parameter.

19. The method of claim 12 further including adjusting the center wavelength used for filtering further to reduce optical wavelength drift.

20. The method of claim 12 further including adjusting the center wavelength used for the filtering further as a function of minimizing the difference between measurements of optical power by the optical power detectors.

21. The method of claim 12 further including adjusting the center wavelength used for the filtering as a function of maximizing the measurements of optical power by the output optical power detector.

22. The method of claim 12 further including applying dither control to the filtering and adjusting the center wavelength used for the filtering as a function of the dither control.

23. A tunable filter for shaping a channel signal within a dense wavelength division multiplexing (DWDM) signal comprising:
an adjustment module to adjust a center wavelength of the tunable filter as a function of a difference between measurements of optical powers of a modulated source channel signal input to the tunable filter and a filtered modulated source channel signal output by the tunable filter.

24. A method for adjusting a center wavelength of a tunable filter used for shaping a channel signal within a dense wavelength division multiplexing (DWDM) signal, the method comprising:
adjusting a center wavelength of the tunable filter as a function of a difference between measurements of optical powers of a modulated source channel signal input to the tunable filter and a filtered modulated source channel signal output by the tunable filter.

25. An apparatus for adjusting a center bandwidth of a tunable filter, the apparatus comprising:
a filtering module to filter a modulated source channel signal to produce a filtered modulated source channel signal;
a measurement module to measure an optical power of the modulated source channel signal and the filtered modulated source channel signal; and
an adjustment module to adjust the center bandwidth of a tunable filter as a function of a difference between measurements of the optical power of the modulated source channel signal and the filtered modulated source channel signal.

26. The apparatus of claim 25 wherein the adjustment module is configured to adjust the center bandwidth of the tunable filter as a function of minimizing the difference between measurements of the optical power of a modulated source channel signal and the filtered modulated source channel signal.

27. The apparatus of claim 25 wherein the adjustment module is configured to adjust the center bandwidth of the tunable filter as a function of maximizing the measurement of the optical power of the filtered modulated source channel signal.

28. A method for adjusting a center bandwidth of a tunable filter, the method comprising:
measuring an optical power of a modulated source channel signal;
filtering the modulated source channel signal using the tunable filter to produce a filtered modulated source channel signal;
measuring an optical power of the filtered modulated source channel signal; and
adjusting the center bandwidth of a tunable filter as a function of a difference between measurements of the optical power of the modulated source channel signal and the filtered modulated source channel signal.

29. The method of claim 28 further including adjusting the center bandwidth of the tunable filter as a function of minimizing the difference between measurements of the optical power of a modulated source channel signal and the filtered modulated source channel signal.

30. The method of claim 28 further including adjusting the center bandwidth of the tunable filter as a function of maximizing the measurement of the optical power of the filtered modulated source channel signal.

31. A tunable filter for shaping a channel signal within a dense wavelength division multiplexing (DWDM) signal comprising:
an adjustment module to adjust a center wavelength of the tunable filter as a function of pilot tone control of a modulated source channel signal and a filtered modulated source channel signal; and
a shaping module to shape the channel signal as a function of the adjusted center wavelength.

32. The tunable filter of claim 31 wherein a pilot tone modulates of the source channel signal using at least one of: amplitude modulation, frequency modulation, or phase modulation.

33. The tunable filter of claim 31 wherein the adjustment unit adjusts the center wavelength of the tunable filter as a function of minimizing a difference between pilot tone modulation parameters of the modulated source channel signal and pilot tone modulated parameters of the filtered modulated source channel signal.

34. A method for shaping a channel signal within a dense wavelength division multiplexing (DWDM) signal, the method comprising:
adjusting a center wavelength of a tunable filter used to filter a channel signal of the DWDM signal as a function of pilot tone control of a modulated source channel signal and a filtered modulated source channel signal; and
shaping the channel signal as a function of the adjusted center wavelength.

35. The method of claim 34 wherein a pilot tone modulates source channel signal using at least one of: amplitude modulation, frequency modulation, or phase modulation.

36. The method of claim 34 further including adjusting the center wavelength of the tunable filter as a function of minimizing a difference between pilot tone modulation parameters of the modulated source channel signal and pilot tone modulated parameters of the filtered modulated source channel signal.
